(19) United States
(12) Patent Application Publication
(10) Pub. No.: US 2004/0215444 A1
(43) Pub. Date: Oct. 28, 2004

(54) Hardware-translator-based custom method invocation system and method

(76) Inventors: Mukesh K. Patel, Fremont, CA (US); Udaykumar R. Raval, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/107,091

(22) Filed: Mar. 25, 2002

(51) Int. Cl. G06F 17/28

(52) U.S. Cl. 704/2

(57) ABSTRACT

A system for implementing Java methods is described in which a Java virtual machine replaces normal method invocation instructions with custom method invocation instructions which are recognized by a hardware translator. The hardware translator can then use stored instructions from a microcode unit to cause a processor to set up a special hardware unit.

### BACKGROUND OF THE INVENTION

The present invention relates to hardware units for translating Java bytecodes into register-based instructions that can be executed by a processor and Java accelerators. Additionally, the invention is applicable to software based Java execution.

Java™ is an object-orientated programming language developed by Sun Microsystems. The Java language is small, simple and portable across platforms and operating systems, both at the source and binary level. This makes the Java programming language very popular on the Internet.

Java's platform independence and code compaction are the most significant advantages of Java over conventional programming languages. In conventional programming languages, the source code of a program is sent to a compiler which translates the program into machine code or processor instructions. The processor instructions are native to the system's processor. If the code is compiled on an Intel-based system, the resulting program will run only on other Intel-based systems. If it is desired to run the program on another system, the user must go back to the original source code, obtain a compiler for the new processor, and recompile the program into the machine code specific to that other processor.

Java operates differently. The Java compiler takes a Java program and, instead of generating machine code for a specific processor, generates bytecodes. Bytecodes are instructions that look like machine code. To execute a Java program, a bytecode interpreter takes the Java bytecodes and converts them to equivalent native processor instructions and executes the Java program. The Java bytecode interpreter is one component of the Java Virtual Machine (JVM).

Having the Java programs in bytecode form means that instead of being specific to any one system, the programs can be run on any platform and any operating system as long as a Java Virtual Machine is available. This allows a binary bytecode file to be executable across platforms.

The disadvantage of using bytecodes is execution speed. System-specific programs that run directly on the hardware for which they are compiled run significantly faster that Java bytecodes, which must be processed by the Java Virtual Machine on that machine. The processor must both convert the Java bytecodes into native instructions in the Java Virtual Machine and execute the native instructions.

Poor Java software performance, particularly in embedded system designs, is a well-known issue and several techniques have been introduced to increase performance. However these techniques introduce other undesirable side effects. The most common techniques include increasing system and/or microprocessor clock frequency, modifying a JVM to compile Java bytecodes and using a dedicated Java microprocessor.

Increasing a microprocessor's clock frequency results in overall improved system performance gains, including performance gains in executing Java software. However, frequency increases do not result in one-for-one increases in Java software performance. Frequency increases also raise power consumption and overall system costs. In other words, clocking a microprocessor at a higher frequency is an inefficient method of accelerating Java software performance.

Compilation techniques (e.g., just in time “JIT” compilation) contribute to erratic performance because the latency of software execution is delayed during compilation. Compilation also increases system memory usage because compiling and storing a Java program consumes an additional five to ten times the amount of memory over what is required to store the original Java program.

Dedicated Java microprocessors use Java bytecode instructions as their native language, and while they execute Java software with better performance than typical commercial microprocessors they impose several significant design constraints. Using a dedicated Java microprocessor requires the system design to revolve around it and forces the utilization of specific development tools usually only available from the Java microprocessor vendor. Furthermore, all operating system software and device drivers must be custom developed from scratch because commercial software of this nature does not exist.

A number of Java instructions concern methods. As explained in “The Java Virtual Machine Specification” (Yellin et al.), there are two kinds of methods, namely ‘instance methods’ and ‘class (static) methods’. Before an instance method can be invoked, an instance is required while class methods do not require an instance. Also, instance methods use late binding while class methods use static or early binding. When class methods are invoked by the Java Virtual Machine, the invoked method is selected based on the object reference which is known at compile time. Instance methods are invoked by the Java Virtual Machine by selecting the method to be invoked based on the actual class of the object which is only known at runtime. Some of the Java bytecodes which invoke methods are invokevirtual, invokestatics, ivokeinterface, etc.

FIG. 8 shows how a compiler generates bytecodes from Java programs for invoking methods. References to methods are initially symbolic. All invoke instructions refer to a constant pool entry that initially contains a symbolic reference. When the JVM encounters an invoke instruction, the symbolic reference is resolved by doing various checks and locating the method and the symbolic reference is replaced with a direct reference. The process of resolving references and invoking methods can be very slow. Commonly known techniques to get around the slow execution is to rename the invoke instruction as invoke quick after resolving the symbolic reference. This now becomes a new instruction, identified as one that can do a very fast invoke of a method if encountered by the JVM again. Invoke instructions are used for invoking Java methods as well as native methods. For Java methods the virtual machine creates a new stack frame (method's local variables, operand stack and other data required by the JVM) for each Java method it invokes. The size of the operand stack and local variables is calculated at compile time and placed in the class file. When the JVM invokes a Java method, it creates a stack frame of the proper size and pushes the new stack frame onto the Java stack (comprising multiple stack frames). For instance methods, the JVM pops the reference and arguments from the operand stack of the calling method's stack frame. The JVM places the reference on the new stack frame as local variable 0 and all the arguments are placed as local variables thereafter, i.e. local variable 1, 2, 3, etc. For a class method only the arguments from the calling method's operand stack are placed on the new stack frames local variables 1, 2, 3, etc. Once the arguments (and the reference in the case of instance methods) are placed on the new stack frame, the JVM makes the new stack frame current and sets the program counter to point to the first instruction of the new method. There are several instructions to return from a method. If there is a return value, it must be on the operand stack. This return value is popped from the operand stack and pushed on the operand stack of the calling method's stack frame. The current method's stack frame is popped and the calling method's stack frame is made current. The program counter is set to the instruction following the calling method instruction that invoked the method. While the above discussion relates to Java methods, it is possible for a JVM to invoke native methods which are usually implementation dependant. When a native method is invoked, the JVM does not push a new stack frame onto the Java stack. Arguments can be passed from the calling method's operand stack and return values returned to the operand stack. The Java stack is once again used when the native method returns. A number of Java methods can be implemented in libraries which are maintained locally at the system. The Java program can access these at local libraries and use them to implement a number of different functions. These functions include graphics functions. Examples of a local library defined by Java is the LCD display, PNG image decoder or multimedia library. In order to speed the operation of these Java applications, often native methods are used. Native methods are Java methods whose implementation are written in another programming language such as C or C++. The use of the native method allows the Java method to operate quicker because the implementation is in a compiled language rather than in an interpreted language such as Java.

These invoke instructions are usually followed by a constant pool index or a direct reference replacing the constant pool index.

It is desired to have an improved system for dealing with method invocation wherein the applications can directly and efficiently execute methods with high performance with and without special hardware to accelerate the methods.

### SUMMARY OF THE INVENTION

An exemplary embodiment of the present invention consists of a Java Virtual Machine (JVM) running on a CPU supported by an operating system. The system may or may not have hardware assist for executing Java code. The hardware assist may be in the form of a co-processor or integrated within the CPU. The system has Java libraries which are resident on the system or device (e.g. cell phones or Set Top Boxes) for executing various functions as called by applications. These applications can be simple such as scan the keys on a cell phone to more complex such as draw an image or multimedia images on the cell phone screen. One example of the Java hardware assist would be an accelerator which uses microcode. The applications could invoke methods within the resident Java or native libraries on the device for some of the functions described above. The libraries can also be dynamically downloaded over a wired or wireless network such as Ethernet, GSM, etc.

One embodiment of the invention includes a hardware translator unit for Java, wherein a custom method invocation instruction, the invoke-custom instruction (different than the invoke-special instruction as specified in the Java Virtual Machine specification), causes the hardware translator unit to construct register-based instructions to be sent to a processor so that the processor initializes a special or custom hardware unit to run the method in whole or in part. In this way, the special hardware unit can run the method separately from and in parallel to the operations of the processor. Prior to calling the invoke-custom method, appropriate arguments and/or reference would be pushed onto the operand stack. Regular invokes are usually followed by a constant pool reference of a direct reference to a method whereas the invoke-custom method is followed by device, function and type information in one embodiment.

In one embodiment, the invoke-custom method invocation instruction is a Java bytecode which is not assigned by the Java specification or the implementation dependent bytecodes (254 and 255) where it is possible to have multiple bytes after the bytecode. When a Java application is started, the system or device causes the JVM to be invoked and while running the virtual machine, the hardware translator is enabled when the interpreter loop is encountered. The hardware translator starts decoding the bytecodes and generates register-based instructions. The register-based instructions could be for RISC, CISC, DSP SIMD, VLIW etc. units. When the translator encounters a native method invoke, the normal invoke instruction is replaced by an invoke-custom invocation instruction. This can be done directly by the hardware translator or by generating an exception or performing a callback to a host processor. The translator can be integrated within the host processor in one embodiment. Thereafter, when the custom invocation instruction is loaded into the hardware translator unit, the register-based instructions are constructed using the microcode unit. The register-based instructions cause the special hardware translator unit to be set up to run the method. Examples of a special hardware units include a graphics engine, a video engine, a single-instruction multiple data (SIMD) unit, a digital signal processor (DSP), and a direct memory access (DMA) unit or other computing and processing units which may be implemented as software or hardware.

### BRIEF DESCRIPTION OF THE DRAWING FIGURES

FIG. 1 is a flow chart that illustrates the operation of one embodiment of the system of the present invention.

FIG. 2 is a diagram of one embodiment of the system of the present invention.

FIG. 3 is a diagram illustrating one embodiment of the system of the present invention in which a dedicated execution engine (CPU) is used.

FIG. 4 is a diagram that illustrates one embodiment of a system of the present invention in which the special hardware is a graphics acceleration engine.

FIG. 5 is a diagram of one embodiment of the system of the present invention in which the processor is used to execute translated instructions from a hardware translator and native instructions that bypass the hardware translator.

FIG. 6 is a diagram that illustrates one embodiment of the method of the present invention.

FIG. 7 is a diagram that illustrates one example for the system of FIG. 6.

FIG. 8 is a diagram of an invoke custom instruction.

FIG. 9 is a diagram illustrating the use of device, function and type in an instruction.

### DETAILED DESCRIPTION OF THE INVENTION

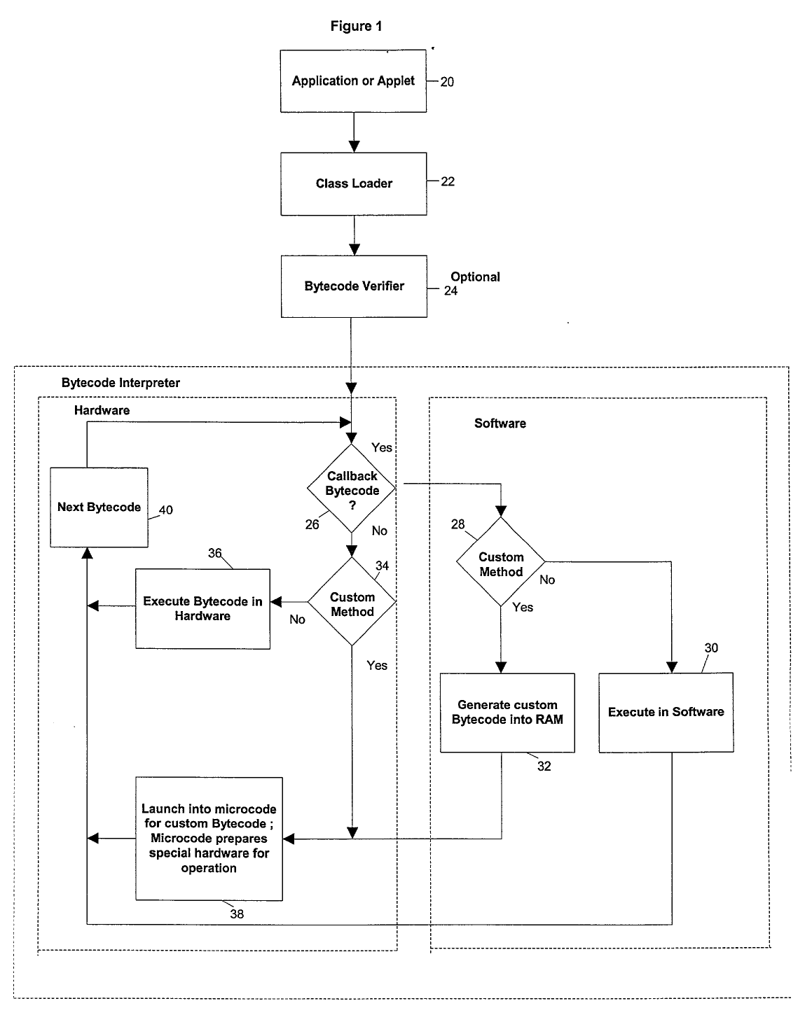

FIG. 1 is a diagram that illustrates one embodiment of the system of one embodiment of the present invention. In step 20, the application or applet is provided. In step 22 a class loader loads the classes that are required for the application to run. In the optional step 24, a bytecode verifier ensures that all the bytecodes are valid. Once the bytecode verifier determines that the bytecodes are valid, the system goes into a bytecode interpreter. In step 26, a hardware translator unit determines whether the bytecode is a callback bytecode. If “yes,” the hardware translator unit causes a virtual machine, such as a modified Java virtual machine, to be loaded into a processor. The software checks to see whether the method is a invoke-custom method in step 28. If not, the bytecode is executed in software in step 30, and control is returned to the hardware. If the method is a invoke-custom method, the invoke-custom bytecode is generated and stored into random access memory (RAM) in step 32. In one embodiment, the invoke-custom bytecode is an unassigned bytecode. This new bytecode would be an invoke-custom bytecode preferably with resolved references The replacement is preferably done after the bytecode verifier checks the bytecode. The hardware unit, if the instruction is not a callback bytecode, checks to see whether it is a invoke-custom bytecode in step 34. If it is not a invoke-custom bytecode, the bytecode is executed in hardware in step 36. If it is a invoke-custom bytecode, in step 38 the hardware system launches into the microcode for the invoke-custom bytecode. The microcode prepares a special hardware unit for operation, such as graphics unit where Xstart, Ystart, Xend, Yend and color are written into hardware registers for drawing lines. Alternatively in step 38 the invoke-custom instruction is executed in software where the special hardware units registers are read or written. In step 40, the next bytecode is checked. Notice that the microcode in the hardware unit is used to execute the invoke-custom method once the invoke-custom bytecode is replaced for the normal bytecode.

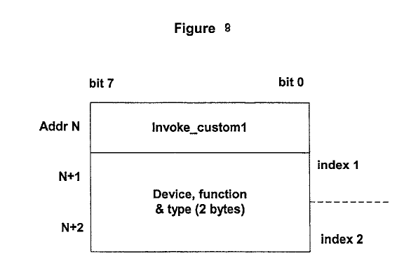

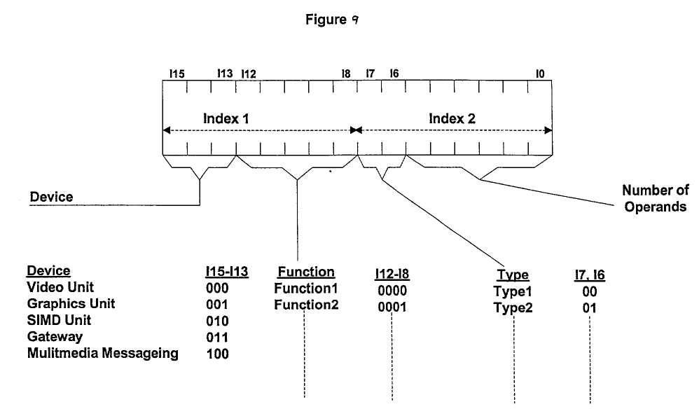

The length of the entire invoke-custom instruction is three bytes and is the same as regular invoke instructions which are one byte for the instruction and two bytes for the index. Keeping the length of the instruction the same avoids recalculating the relative references provided by other bytecodes with the code being executed. This instruction length can be increased with special indirection encoding in some of the bits of the index. FIG. 9 shows an example of how device, function and type can be deployed in place of the index field. The two index bytes (I15-I0) may be represented as I15-I13→provide 8 device types (e.g. video unit (000), graphics unit (001), SIMD unit (010), Network gateway (011), multi-media messaging (100), . . . etc.), I12-I8→provide 16 functions for each of the 8 devices, I7-I6→provides 4 types of parameters for each type of function and I6-I0 is the number of arguments (up to 128) on the stack for the particular device, function and parameter. An example would be a graphics hardware unit where the application wants to draw an anti-aliases line so one possible assignment would be I15-I13→001 (graphics unit), I12-I8→0000 (line draw function), I7-I6→00 (anti-aliased), and I6-I0→0000101 (5 operands, Xstart, Ystart, Xend, Yend, and Color). The assignment of the particular its in the index field can vary according to the needs of the particular implementation and function for the kind of product to be commercialized. An example of such assignment of the index bits is shown in FIG. 8. The above example pertains to one particular realization of an invoke-custom instruction. It is equally possible to have multiple invoke-custom instructions, i.e. invoke-custom 2, invoke-custom 3, etc., each followed by its own definition of the two byte index fields. This provides for a powerful means to directly access hardware functionality or particular device drivers. The index bits can be parsed by software or microcode or decoded in hardware. In one embodiment, the invoke-custom bytecode would be decoded by hardware and provide an entry point for the microcode. The bytecode itself can be an entry point for the microcode as well. The microcode can read the device, function and type field of the index and appropriately enable hardware or provide a reference to where the drivers are for that hardware. Alternatively the microcode could provide a reference for where to execute that method in software. In another embodiment, the software interpreter would decode the invoke-custom bytecode and directly write or enable the hardware to execute the method. It is also possible to indicate the method type by simply having a particular value in the index fields. Another way to provide the type of device and function, etc., is in the arguments of the invoke-custom method.

An exemplary embodiment of the present invention comprises a hardware translator unit receiving intermediate language instructions and producing native instructions such as a register-based instruction for RISC, CISC, DSP, VLIW, SIMD etc. devices. At least one intermediate language instruction is a custom method invocation for which the hardware translator unit constructs register-based instructions to be sent to a processor so that the processor initializes a special hardware unit to run the method.

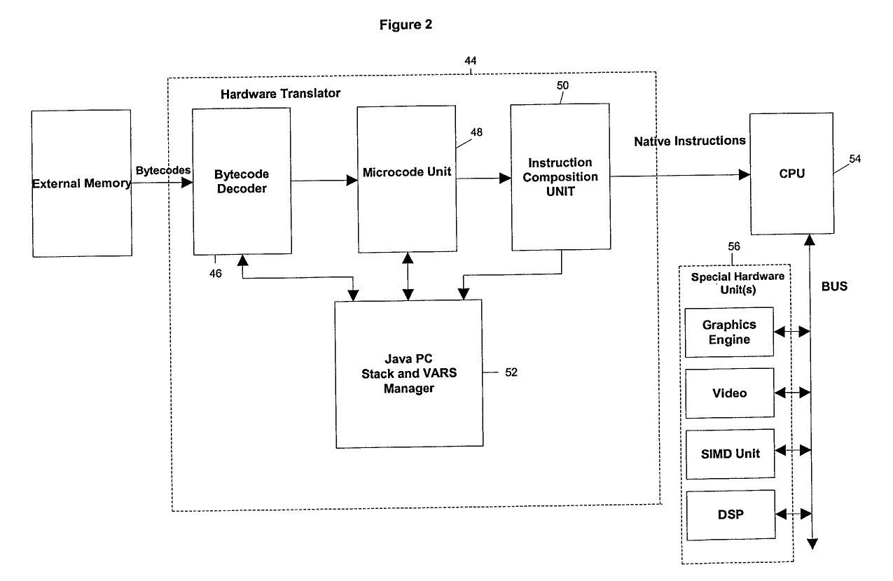

In the example of FIG. 2, the hardware translator unit 44 receives intermediate language instructions and produces register-based instructions. At least one intermediate language instruction is a custom method invocation for which the hardware translator unit constructs register-based instructions to be sent to a processor 54 so that the processor initializes a special hardware unit 56 to run the method.

In one embodiment, the custom method causes data to be directly written to or read from the special hardware unit. In one embodiment, the data is sent to the special hardware unit over a bus. In one embodiment, the bus is a coprocessor bus. In one embodiment, the bus is a system bus.

In one embodiment, the register-based instruction are for DSP, VLIW, SIMD, CISC and general purpose processors, including legacy processors. In one embodiment, the hardware translator produces instructions for a legacy processor of any kind.

In one embodiment, index bits of the intermediate language instructions for the custom method invocation are redefined to specify the type of method to execute. In one embodiment, the index bits are replaced by a device function and type field.

In one embodiment, the operand field bits of the intermediate language instructions for the custom method invocation are redefined to specify the type of method to execute. In one embodiment, the operand field bits are replaced by a device function and type field bits.

In one embodiment, the operand field bits and index bits of the intermediate language instructions for the custom method invocation are redefined to specify the type of method to execute. In one embodiment, the operand field bits and index bits are replaced by a device function and type field bits.

In one embodiment, the hardware translator is a hardware accelerator.

In an exemplary embodiment, a system comprises a hardware translator unit receiving intermediate language instructions and producing register-based instructions. The at least one method invocation results in the hardware unit passing control to a virtual machine running in software that replaces the instruction for the method invocation in memory with a custom method invocation instruction. The custom method invocation instruction causes the hardware translator unit constructs register-based instructions to be sent to a processor so that the processor initializes a custom hardware unit to run the method.

In the example of FIG. 2, hardware translator unit 44 receives intermediate language instructions and producing register-based instructions. The hardware translator unit 44 producing at least portions of register-based instructions for execution. The at least one method invocation results in the hardware translator unit 44 passing control to a virtual machine running in software that replaces the instruction for the method invocation in memory with a custom method invocation instruction. The custom method invocation instruction causes the hardware translator unit 44 constructs native instructions to be sent to a processor 54 so that the processor initializes a special hardware unit to run the method.

In an exemplary embodiment, a hardware translator unit receives intermediate language instructions and produces register-based instructions. At least one intermediate language instruction is a special graphics method invocation for which the hardware translator constructs register-based instructions to be sent to a processor so that the processor initializes a graphics engine to run the method.

In the example of FIG. 2, hardware translator unit 44 receives intermediate language instructions and produces register-based instructions. At least one intermediate language instruction is a special graphics method invocation for which the hardware translator unit constructs register-based instructions to be sent to a processor so that the processor initializes a graphics engine to run the method.

FIG. 2 illustrates one embodiment of the system of the present invention. The hardware translator unit 44 translates intermediate language instructions into register-based instructions. The intermediate language instructions are preferably Java bytecodes. Note that other intermediate language instructions, such as MSIL for .NET/C# or Multos bytecodes, can be used as well. For simplicity, the remainder of the specification describes an embodiment in which Java is used, but other intermediate language instructions can be used as well.

In one embodiment, the hardware translator 44 translates Java bytecodes into native instructions that can be run by the processor. By doing the translation in hardware, the operation of the Java program can be significantly speeded up. A description of a Java translator unit is given in patent application Ser. No. 09/208,741. This translator can also be integrated in the CPU.

In one embodiment, the hardware translator unit 44 includes a bytecode decoder 46, a microcode unit 48, an instruction composition unit 50, and a Java Program Counter (PC), stack and variable manager 52. In the preferred embodiment, the bytecode decoder 46 decodes the bytecodes as they are received. The microcode unit 48 stores the portions of the translated instructions. The stack and variable manager 52 supplies the register indications to the instruction composition unit 50 so that the registers which store the portions of the Java operand stack are accessed. The stack and variable manager 52 also causes the microcode unit 48 to produce instructions that cause the manipulation of the portions of the Java operand stack or variable stored in the register file of CPU 54. By storing portions of the Java operand stack and variables in the register file of the CPU 54, the system of the present invention can operate more efficiently. The system of the present invention can, however, also operate without a stack and variable manager 52, but it would operate much less efficiently. As will be described below, in addition to the normal translated instructions in the microcode unit 48, the microcode unit 48 will also store instructions for the invoke-custom methods which are indicated by the invoke-custom method invoke instructions. As described above, the invoke-custom method invoke instructions are indicated by at least one unassigned Java bytecode or the user defined bytecode, which has been written into the instruction memory by the modified Java virtual machine or is in the resident libraries.

The microcode instructions are sent as the translated register-based instructions to the CPU 54. The CPU 54 then sets up the special hardware unit 56. Note that the special hardware unit can be a graphics engine, a video engine, a single-instruction multiple data (SIMD) unit, a digital signal processor (DSP), a direct memory access (DMA) unit, or any other type of special hardware unit.

In a preferred embodiment, the CPU 54 sets up registers in the special hardware unit so that the special hardware unit can run the method in parallel to the normal operations of the system, i.e. the method can be dispatched and the translator can continue with the next bytecode instruction. Typically, the special hardware unit will produce an interrupt to the CPU when it is finished or the CPU can poll a done flag or status register. Alternately, the CPU can halt its operations until the special hardware units are finished.

In one embodiment, the decoded bytecodes from the bytecode decode unit are sent to a state machine unit and an Arithmetic Logic Unit (ALU) in the instruction composition unit. The ALU is provided to rearrange the bytecode instructions to make them easier to be operated on by the state machine and perform various arithmetic functions including computing memory references. The state machine converts the bytecodes into native instructions using the microcode table. Thus, the state machine provides an address which indicates the location of the desired native instruction in the microcode table. Counters or other indications are maintained to keep a count of how many entries have been placed on the operand stack, as well as to keep track of and update the top of the operand stack in memory and in the register file. In a preferred embodiment, the output of the microcode table is augmented with indications of the registers to be operated on in the register file. The register indications are from the counters and interpreted from bytecodes. To accomplish this, it is necessary to have a hardware indication of which operands and variables are in which entries in the register file. Native instructions are composed on this basis. Alternately, these register indications can be sent directly to the register file.

In another embodiment of the present invention, the Stack and Variable (Var) manager assigns Stack and Variable values to different registers in the register file. An advantage of this alternate embodiment is that in some cases the Stack and Var values may switch due to an Invoke Call and such a switch can be more efficiently done in the Stack and Var manager rather than producing a number of native instructions to implement this.

In one embodiment, a number of important values can be stored in the hardware translator to aid in the operation of the system. These values stored in the hardware translator help improve the operation of the system, especially when the register files of the execution engine are used to store portions of the Java stack.

The hardware translator unit preferably stores an indication of the top of the stack value (memory reference of the top stack element). Additionally, the translator may keep an indication of which register in the CPU's register file has the top of stack content. This top of the stack value aids in the loading of stack values from the memory. The top of the stack value is updated as instructions are converted from stack-based instructions to register-based instructions. The register in the translator which keeps an indication of which register in the CPU's register file has top of stack would also get updated. When instruction level parallelism is used, each stack-based instruction which is part of a single register-based instruction needs to be evaluated for its effects on the Java stack.

In one embodiment, an operand stack depth value is maintained in the hardware translator. This operand stack depth indicates the dynamic depth of the operand stack in the execution engine (CPU) register files. For example, if eight stack values are stored in the register files, the stack depth indicator will read “8.” Knowing the depth of the stack in the register file helps in the loading and storing of stack values in and out of the register files.

In a preferred embodiment, a minimum stack depth value and a maximum stack depth value are maintained within the hardware translator unit. The stack depth value is compared to the maximum and minimum stack depths. When the stack value goes below the minimum value, the hardware translator unit composes load instructions to load stack values from the memory into the register file of the execution engine. When the stack depth goes above the maximum value, the hardware translator unit composes store instructions to store stack values back out to the memory.

In one embodiment, at least the top eight (8) entries of the operand stack in the execution engine register file operated as a ring buffer, the ring buffer maintained in the translator and operably connected to a overflow/underflow unit.

The hardware translator unit also preferably stores an indication of the operands and variables stored in the register file of the execution engine. These indications allow the hardware translator to compose the converted register-based instructions from the incoming stack-based instructions.

The hardware translator unit also preferably stores an indication of the variable base and operand stack base in the memory. This allows for the composing of instructions to load and store variables and operands between the register file of the execution engine and the memory. For example, when a Var is not available in the register file, the hardware issues load instructions. The hardware adapted to multiply the Var number by four and adding the Var base to produce the memory location of the Var. The instruction produced is based on knowledge that the Var base is in a temporary native execution engine register. The Var number times four can be made available as the immediate field of the native instruction being composed, which may be a memory access instruction with the address being the content of the temporary register holding a pointer to the Vars base plus an immediate offset. Alternatively, the final memory location of the Var may be read by the execution engine with an instruction the translator and then the Var can be loaded.

In one embodiment, the hardware translator unit marks the variables as modified when updated by the execution of Java bytecodes. The hardware translator can copy variables marked as modified to the system memory for some bytecodes.

In one embodiment, the hardware translator unit composes native instructions wherein the native instructions operands contains at least two native execution engine register file references where the register file contents are the data for the operand stack and variables.

In one embodiment a stack-and-variable-register manager maintains indications of what is stored in the variable and stack registers of the register file of the execution engine. This information is then provided to the decode stage and microcode stage in order to help in the decoding of the Java bytecode and generating appropriate native instructions.

In a preferred embodiment, one of the functions of a Stack-and-Var register manager is to maintain an indication of the top of the stack. Thus, if for example registers R1-R4 store the top 4 stack values from memory or by executing byte codes, the top of the stack will change as data is loaded into and out of the register file. Thus, register R2 can be the top of the stack and register R1 be the bottom of the stack in the register file. When a new data is loaded into the stack within the register file, the data will be loaded into register R3, which then becomes the new top of the stack, the bottom of the stack remains R1. With two more items loaded on the stack in the register file, the new top of stack in the register file will be R1 but first R1 will be written back to memory by the translators overflow/underflow unit, and R2 will be the bottom of the partial stack in the register file.

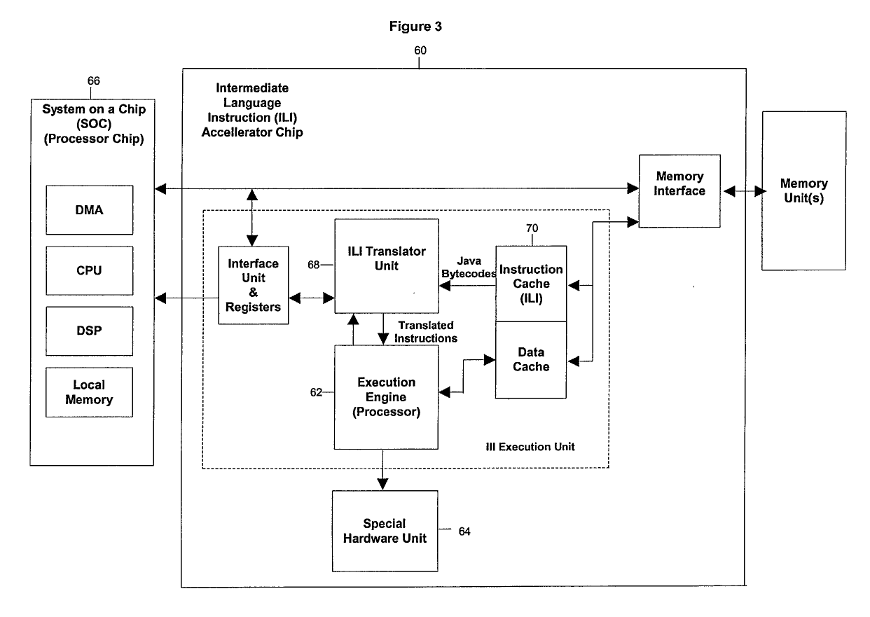

Note that the system of the present invention can be arranged in a number of different ways. FIG. 3 illustrates a system in which an accelerator chip 60 includes a dedicated execution engine processor 62 and the special hardware unit 64. The dedicated execution engine 62 is separate from the processor on the system on a chip 66 which is used to run the Java virtual machine. The execution engine 62 is dedicated for use with the translator unit 68.

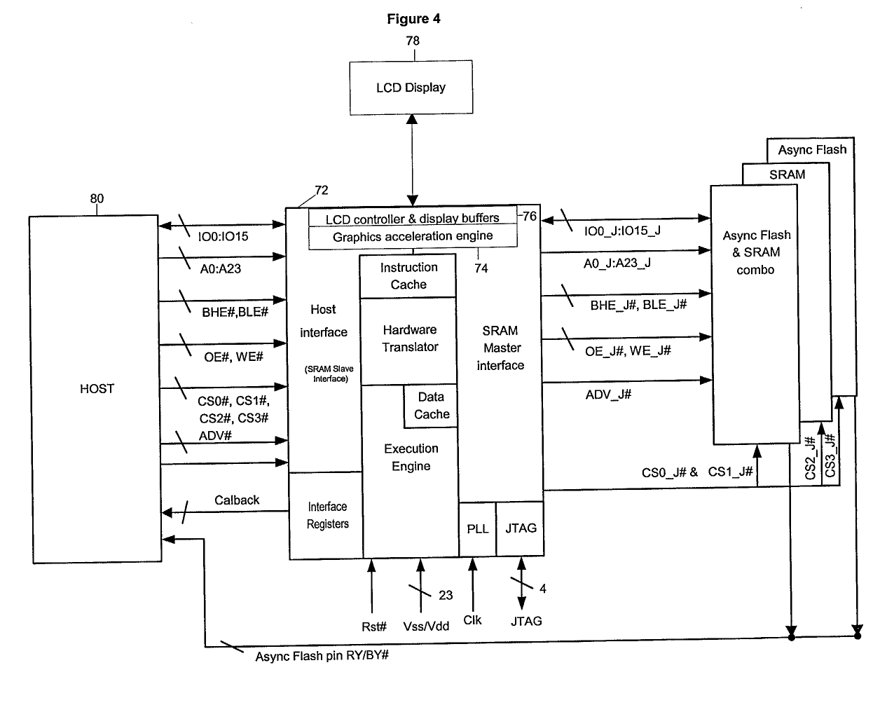

FIG. 4 illustrates an example in which an accelerator chip 72 includes a graphics acceleration engine 74 which acts as a special hardware unit. The graphics accelerator 34 is associated with an LCD controller and display buffer 76 which causes the update of the LCD display 78. Note in this example the accelerator chip operates to control the display of the Java programs onto the LCD display and frame buffer in memory. Alternatively, the frame buffer may be integrated on to the accelerator chip. Other units such as MPEG4 and audio/video decoders and encoders may also be integrated on to the accelerator chip and supported through Java programs as well as native programs. Since the Java programs are more and more being used for graphics, keeping the control of the Java program display at the accelerator chip can allow the system to operate more efficiently than if a native method is used, for which control would be sent to the system on a chip 80. The accelerator chip can also be integrated with a System on Chip (SOC) either in the same silicon or as a multiple die stack with the system on a chip in the same package or a multiple die stack with the memory in the same package.

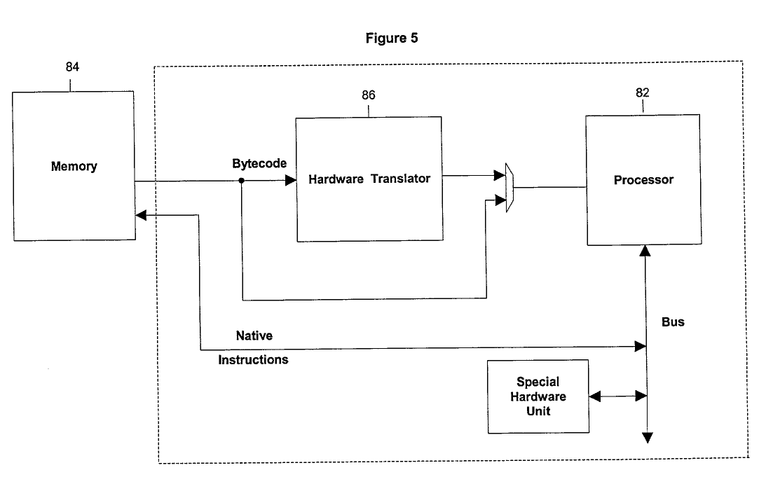

FIG. 5 illustrates an alternate embodiment in which the processor 82 runs native instructions directly from the memory 84 or alternately can run the translated instructions from the hardware translator 86.

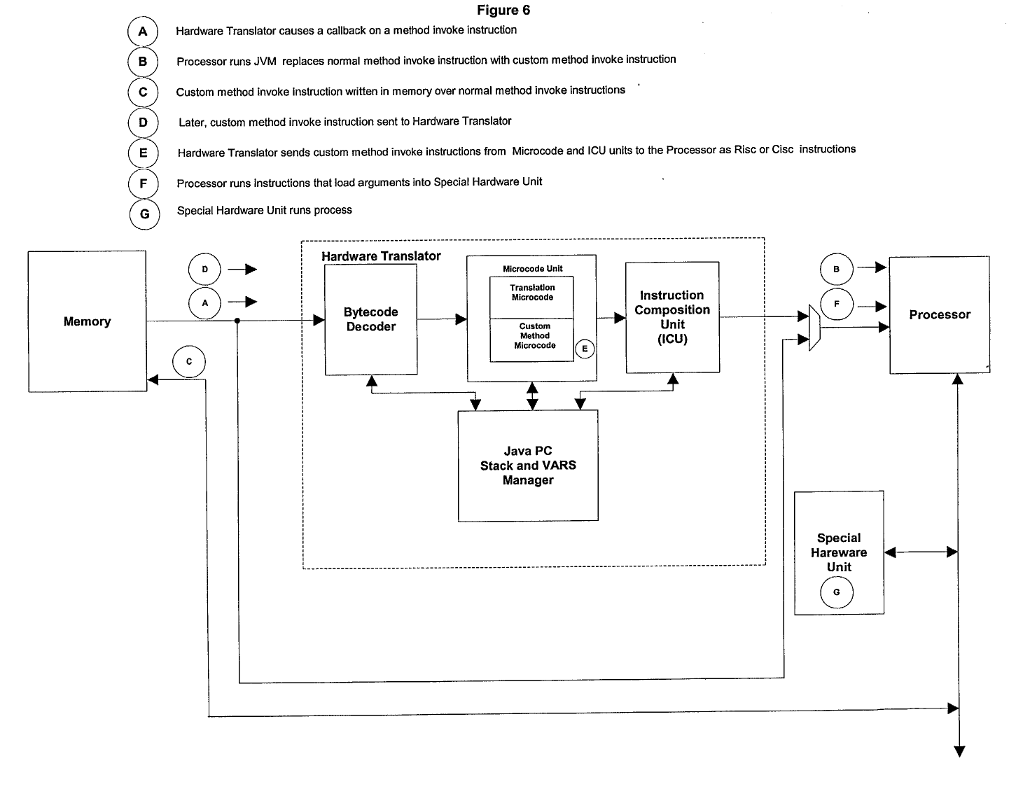

FIG. 6 is a diagram that illustrates the operation of the system of one embodiment of the present invention. Note that in this example, an architecture similar to FIG. 5 is used, but it is to be understood that the method of the present invention will work equally well for architectures of the type of FIG. 3. In step A, the hardware translator causes a callback on a method invoke instruction. In step B, the processor runs a Java virtual machine and replaces the normal method invoke instruction with a invoke-custom method invocation instruction. In step C, the invocation instruction is written into the memory over the normal method invoke instruction. Later, in step D, the invoke-custom method invocation instruction is sent to the hardware translator. In step E, the hardware translator sends invoke-custom method instructions from the microcode unit to the processor. The processor runs the instructions that load arguments onto the special hardware unit. In step G, the special hardware unit runs the process.

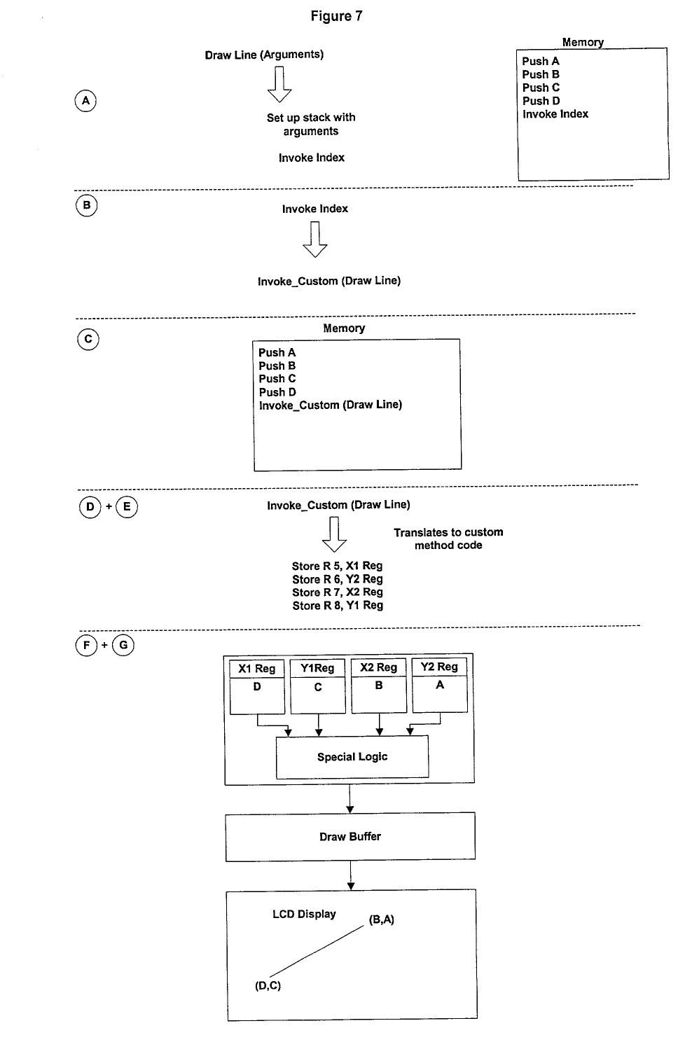

FIG. 7 illustrates an example of such a system in which a graphics display is shown. As shown in step A, a draw line function is translated into bytecodes, some of which set up the stack with arguments, and after which an invoke instruction is issued an index. In step B, the invoke instruction is converted into the invoke_custom instruction. In one embodiment, the invoke_custom instruction has an argument which is a descriptor indicating the type of custom method. Note that only a single special bytecode for the invoke_custom needs to be used, whereas the descriptors substituted in the index field can describe a wide variety of custom functions.

In step C, the invoke instruction is overwritten in memory by the invoke_custom bytecode with the descriptor=draw line. In steps D and E, the invoke_custom draw line is translated by the hardware translator into native instructions that cause the processor to load up the graphics engine with the required argument and cause the graphics engine to execute. In steps F and G, the graphics engine has the arguments loaded into graphics unit registers by the CPU. The graphics engine produces a line between the points (D, C) and (B, A).

FIG. 7 shows a graphics example, but note that a wide variety of different custom methods can be implemented using the system of the present invention. In one embodiment, a single invoke_custom bytecode is used with the following descriptor indicating the specific custom method.

In an exemplary embodiment, the hardware translator unit and the processor is on a single silicon chip. In one embodiment, the hardware translator is integrated with the system on a chip (SOC) on a single silicon die. In an alternate embodiment, the hardware translator unit is placed on a separate chip from the processor. The chip with the processor and the chip with the hardware translator unit can be combined in a stack package or multi-chip package.

In one embodiment, the hardware translator unit is integrated on a single chip along with a memory. The memory can store the intermediate language instructions. In an alternative embodiment, the hardware translator unit can be placed on its own chip and combined along with a memory chip in a stack package or a multi-chip package.

In one embodiment, index bits typically used with the intermediate language instructions are modified to include a descriptor for the custom method. In an alternate embodiment, the description for the custom method is stored onto a stack. In this embodiment, the descriptor values are loaded before the custom method is run.

The present application incorporates by reference the following earlier-filed applications: application Ser. No. 09/208,741 filed Dec. 8, 1998; application Ser. No. 09/488,186 filed Jan. 20, 2000; Application No. 60/239,298 filed Oct. 10, 2000; application Ser. No. 09/687,777 filed Oct. 13, 2000; application Ser. No. 09/866,508 filed May 25, 2001, and Application No. 60/302,891 filed Jul. 2, 2001.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method.

2. The system of claim 1, wherein the native instruction is a register-based instruction.

3. The system of claim 1, wherein the custom method causes data to be directly written to or read from the special hardware unit.

4. The system of claim 3, wherein the data is sent to the special hardware unit over a bus.

5. The system of claim 4, wherein the bus is a coprocessor bus.

6. The system of claim 4, wherein the bus is a system bus.

7. The system of claim 1, wherein index bits of the intermediate language instructions for the custom method invocation are defined to specify the type of method to execute.

8. The system of claim 7 wherein the index bits include device function and type field bits.

9. The system of claim 1, wherein operand field bits on the stack for the custom method invocation are redefined to specify the type of method to execute.

10. The system of claim 1 wherein the operand field bits include device function and type field bits.

11. The system of claim 1, wherein operand field bits in the stack and index bits of the intermediate language instructions for the custom method invocation are defined to specify the type of method to execute.

12. The system of claim 11 wherein the operand field bits and index bits include device function and type field bits.

13. The system of claim 1 wherein the hardware translator is a hardware accelerator.

14. The system of claim 1, wherein the hardware translator unit includes a microcode unit.

15. The system of claim 1 wherein the intermediate language instructions are Java bytecodes.

16. The system of claim 1 wherein the special method invocation is a bytecode not defined by the Java specification.

17. The system of claim 1 wherein an argument of the special method invocation instruction indicates the type of method.

18. The system of claim 1 wherein the special hardware unit is a graphics engine.

19. The system of claim 1 wherein the graphics engine is associated with a display buffer.

20. The system of claim 1 wherein the special hardware unit is a video unit.

21. The system of claim 1 wherein the special hardware unit is a single-instruction multiple data (SIMD) unit.

22. The system of claim 1 wherein the special hardware unit is a DSP.

23. The system of claim 1 wherein the special method instructions are produced by a virtual machine.

24. The system of claim 23 wherein some methods cause the virtual machine to replace normal method invocations with a special method invocation in memory.

25. The system of claim 1 wherein the processor runs the Java virtual machine.

26. The system of claim 1 wherein a separate processor runs the virtual machine.

27. The system of claim 1 wherein the processor is a dedicated processor.

28. The system of claim 1 wherein the processor is a general-purpose processor which runs instructions not provided by the hardware translator unit as well as instructions provided by the hardware translator unit.

29. The system of claim 1 wherein the hardware translator unit includes a microcode unit that interacts with a stack manager in the hardware translator unit to produce the native instructions.

30. The system of claim 1 wherein the hardware translator unit includes a microcode unit that sends the data to an instruction composer which produces the register-based instructions to be sent to the processor.

31. A system comprising:
a hardware translator unit receiving intermediate language instructions and producing register-based instructions, wherein at least one method invocation results in the hardware unit passing control to a virtual machine running in software that replaces the instruction for the method invocation in memory with a custom method invocation instruction, the custom method invocation instruction causes the hardware translator unit to construct at least one register-based instruction to be sent to a processor so that the processor initializes a special hardware unit to run the method.

32. The system of claim 31 wherein the native instruction is a register-based instruction.

33. The system of claim 31 wherein the hardware translator unit includes a microcode unit.

34. The system of claim 31 wherein the intermediate language instructions are Java bytecodes.

35. The system of claim 31 wherein the custom method invocation instruction is not defined by the Java specification.

36. The system of claim 31 wherein an argument to the custom method invocation instruction indicates the type of method.

37. The system of claim 31 wherein the special hardware unit is a graphics engine.

38. The system of claim 31 wherein the processor runs a Java virtual machine.

39. The system of claim 31 wherein a separate processor runs a Java virtual machine.

40. The system of claim 31 wherein the hardware translator unit includes a microcode unit that interacts with a stack manager in hardware translator unit to produce register-based instructions.

41. The system of claim 31 wherein an instruction composer in the hardware translator unit receives data from a microcode unit to produce the register-based instructions.

42. A system comprising:
a hardware translator unit receiving intermediate language instructions and producing native instructions, wherein at least one intermediate language instruction is a custom graphics method invocation for which the hardware translator unit constructs native instructions to be sent to a processor so that the processor initializes a graphics engine to run the method.

43. The system of claim 42 wherein the native instruction is a register-based instruction.

44. The system of claim 42 wherein the hardware translator unit includes a microcode unit.

45. The system of claim 42 wherein the graphics engine is associated with a display buffer.

46. The system of claim 42 wherein the graphics engine is associated with a display.

47. The system of claim 42 wherein the graphics engine produces a display for an LCD display.

48. The system of claim 42 wherein the intermediate language instructions are Java bytecodes.

49. The system of claim 42 wherein the custom method invocation instruction is not defined in the Java specification.

50. The system of claim 42 wherein an argument to the custom method invocation instruction indicates the type of method.

51. The system of claim 42 wherein the custom method instructions are produced by a virtual machine.

52. The system of claim 51 wherein some methods cause the virtual machine to replace the normal method invocation instruction with a custom method invocation instruction.

53. The system of claim 42 wherein the processor runs a virtual machine.

54. The system of claim 42 wherein a separate processor runs the virtual machine.

55. The system of claim 42 wherein a microcode unit interacts with the stack manager and the hardware translator unit to produce register-based instructions.

56. The system of claim 42 wherein an instruction composer in the hardware translator unit receives data from a microcode unit to produce the native instructions sent to the processor.

57. A method comprising:
in a hardware translator unit, receiving intermediate language instructions and producing native instructions, wherein at least one intermediate language instruction is a custom method invocation for which the hardware translator unit constructs a custom native instruction to be sent to a processor; and
in the processor, in response to the custom native instruction, initializing a special hardware unit to run the custom method.

58. The method of claim 57, wherein the custom method causes data to be directly written to or read from the special hardware unit.

59. The method of claim 57, wherein the data is sent to the special hardware unit over a bus.

60. The method of claim 59, wherein the bus is a coprocessor bus.

61. The method of claim 57, wherein the bus is a system bus.

62. The method of claim 57, wherein index bits of the intermediate language instructions for the custom method invocation are defined to specify the type of method to execute.

63. The method of claim 62, wherein the index bits include device function and type field bits.

64. The method of claim 57, wherein operand field bits on the stack for the custom method invocation are redefined to specify the type of method to execute.

65. The method of claim 57, wherein the operand field bits include device function and type field bits.

66. The method of claim 57, wherein operand field bits in the stack and index bits of the intermediate language instructions for the custom method invocation are defined to specify the type of method to execute.

67. The method of claim 66 wherein the operand field bits and index bits include device function and type field bits.

68. The method of claim 57 wherein the hardware translator is a hardware accelerator.

69. The method of claim 57, wherein the unit includes a microcode unit.

70. The method of claim 57 wherein the intermediate language instructions are Java bytecodes.

71. The method of claim 57 wherein the custom method invocation is a bytecode not defined by the Java specification.

72. The method of claim 57 wherein an argument of the custom method invocation instruction indicates the type of method.

73. The method of claim 57 wherein the special hardware unit is a graphics engine.

74. The method of claim 57 wherein the graphics engine is associated with a display buffer.

75. The method of claim 57 wherein the special hardware unit is a video unit.

76. The method of claim 57 wherein the special hardware unit is a single-instruction multiple data (SIMD) unit.

77. The method of claim 57 wherein the special hardware unit is a DSP.

78. The method of claim 57 wherein the custom method instructions are produced by a virtual machine.

79. The method of claim 78 wherein some methods cause the virtual machine to replace normal method invocations with a custom method invocation in memory.

80. The method of claim 57 wherein the processor runs the Java virtual machine.

81. The method of claim 57 wherein a separate processor runs the virtual machine.

82. The method of claim 57 wherein the processor is a dedicated processor.

83. The method of claim 57 wherein the processor is a general-purpose processor which runs instructions not provided by the hardware translator unit as well as instructions provided by the hardware translator unit.

84. The method of claim 57 wherein the unit interacts with the stack manager in the hardware translator unit to produce the native instructions.

85. The method of claim 57 wherein the unit sends the data to an instruction composer which produces the native instructions to be sent to the processor.

86. The method of claim 57 wherein the native instructions are register-based instructions.

87. A method comprising:
Interpreting an undefined bytecode as a custom bytecode, the custom bytecode causing a processor to initialize a special hardware unit to run the custom method without using a native method; and
running the custom method in the special hardware unit.

88. The method of claim 87, wherein the custom method causes data to be directly written to or read from the special hardware unit.

89. The method of claim 88, wherein the data is sent to the special hardware unit over a bus.

90. The method of claim 89, wherein the bus is a coprocessor bus.

91. The method of claim 89, wherein the bus is a system bus.

92. The method of claim 87, wherein index bits of the intermediate language instructions for the custom method invocation are defined to specify the type of method to execute.

93. The method of claim 92, wherein the index bits include device function and type field bits.

94. The method of claim 87, wherein operand field bits on the stack for the custom method invocation are redefined to specify the type of method to execute.

95. The method of claim 87, wherein the operand field bits include device function and type field bits.

96. The method of claim 87, wherein operand field bits in the stack and index bits of the intermediate language instructions for the custom method invocation are defined to specify the type of method to execute.

97. The method of claim 96 wherein the operand field bits and index bits include device function and type field bits.

98. The method of claim 87 wherein the custom method invocation is a bytecode not defined by the Java specification.

99. The method of claim 87 wherein an argument of the custom method invocation instruction indicates the type of method.

100. The method of claim 87 wherein the special hardware unit is a graphics engine.

101. The method of claim 87 wherein the graphics engine is associated with a display buffer.

102. The method of claim 87 wherein the special hardware unit is a video unit.

103. The method of claim 87 wherein the special hardware unit is a single-instruction multiple data (SIMD) unit.

104. The method of claim 87 wherein the special hardware unit is a DSP.

105. The method of claim 87 wherein the custom method instructions are produced by a virtual machine.

106. The method of claim 105 wherein some methods cause the virtual machine to replace normal method invocations with a custom method invocation in memory.

107. The method of claim 87 wherein a hardware unit translates an intermediate language instruction into a native instruction.

108. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein the hardware translator unit and processor are on a single chip.

109. The system of claim 108 wherein the processor is part of a system on a chip.

110. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein the hardware translator unit is on a separate chip from the processor, wherein the processor chip and the hardware translator unit are placed in a stack package or a multi-chip package.

111. The system of claim 110 wherein the processor is part of a system on a chip.

112. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein the hardware translator unit is integrated with a memory which stores the intermediate language instructions, wherein the hardware translator unit and memory are on the same chip.

113. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein the hardware translator unit is formed on a chip which is placed along with a memory chip within a stack package or multi-chip package.

114. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein the custom method invocation uses index bits as descriptors for the custom method.

115. A system comprising:
a hardware translator unit receiving intermediate language instructions and producing native instructions, wherein at least one intermediate language instruction is a custom method invocation for which the hardware translator unit constructs at least one native instruction to be sent to a processor so that the processor initializes a special hardware unit to run the method, and
wherein descriptors for the custom method are loaded onto the stack.
